(19) United States
(12) Patent Application Publication
(10) Pub. No.: US 2008/0261808 A1
(43) Pub. Date: Oct. 23, 2008

(54) Recordable medium with template pattern

(75) Inventors: Andrew Koll, Albany, OR (US); Kyle Merrill, Albany, OR (US); David Leigh, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Fort Collins, CO (US)

(21) Appl. No.: 11/789,085

(22) Filed: Apr. 23, 2007

(51) Int. Cl. B41M 5/20

(52) U.S. Cl. 503/200

(57) ABSTRACT

A recordable medium having a data side and a label side has one or more template patterns printed on the label side, and has at least first indicia including a template-reference-position mark.

### TECHNICAL FIELD

This invention relates to automatic orientation of media labels and recordable media specially adapted for automatic orientation of media labels.

### BACKGROUND

Optical recording technology that enables consumers and others to record laser-written labels on specially coated recordable CD and DVD media has enjoyed notable commercial success. In light-activated thermal label-recording technology, a surface of the medium is coated with a writable layer of a material that changes appearance when it absorbs laser light of a predetermined wavelength.

Optical recording media may be pre-printed with templates (e.g., logo information) while still allowing consumers and others to record laser-written label information on some portion of the media surface. Unless such label template information is so symmetric as to be orientation independent, it is difficult to orient user-written information to the preprinted template. Pre-orienting the label template information to a physical feature such as a flat or notch is generally impractical and expensive. Improved methods and media are needed.

### BRIEF DESCRIPTION OF THE DRAWINGS

The features and advantages of the disclosure will readily be appreciated by persons skilled in the art from the following detailed description when read in conjunction with the drawings, wherein:

FIG. 1 is a side elevation cross-sectional view of an embodiment of a recordable medium.

FIG. 2A is a top plan view of the embodiment of FIG. 1.

FIG. 2B is an enlarged portion of the embodiment shown in FIG. 2A.

FIG. 2C is another enlarged portion of the embodiment shown in FIG. 2A.

FIG. 3 is a flow chart illustrating embodiments of methods for fabricating media embodiments.

FIG. 4 is a flow chart illustrating embodiments of methods for using media embodiments disclosed.

### DETAILED DESCRIPTION OF EMBODIMENTS

For clarity of the description, the drawings are not drawn to a uniform scale. In particular, vertical and horizontal scales may differ from each other and may vary from one drawing to another. In this regard, directional terminology, such as “top,” “bottom,” “front,” “back,” “leading,” “trailing,” etc., is used with reference to the orientation of the drawing figure(s) being described. Because components of the invention can be positioned in a number of different orientations, the directional terminology is used for purposes of illustration and is in no way limiting.

The terms “recordable medium” and “recordable media” as used in this specification and the appended claims refer to media capable of having information recorded thereon by exposure to optical radiation such as laser light. Recordable media may include such media having pre-recorded information readable from at least one side and having an optically-recordable coating on at least the other side for writing a label on the media. The term “recording” refers to recording or printing a label or other information on a recordable medium such as an optical storage disk. The term “media type” as used herein refers generally to a type of recordable medium such as a disk type selected from a set of disk types, such as an optical storage disk, a compact disk (CD), a digital versatile disk (DVD), an HD-DVD, a Blu-ray Disc™ (BD), a holographic versatile disk (HVD), a video disk, or combinations of these media types, for example, but not limited to these media types. Media-type identification information of the recordable medium may comprise a code, such as a digital code, numeric code, alphabetic code, alphanumeric code, bar code, or logo, for example, identifying the media type.

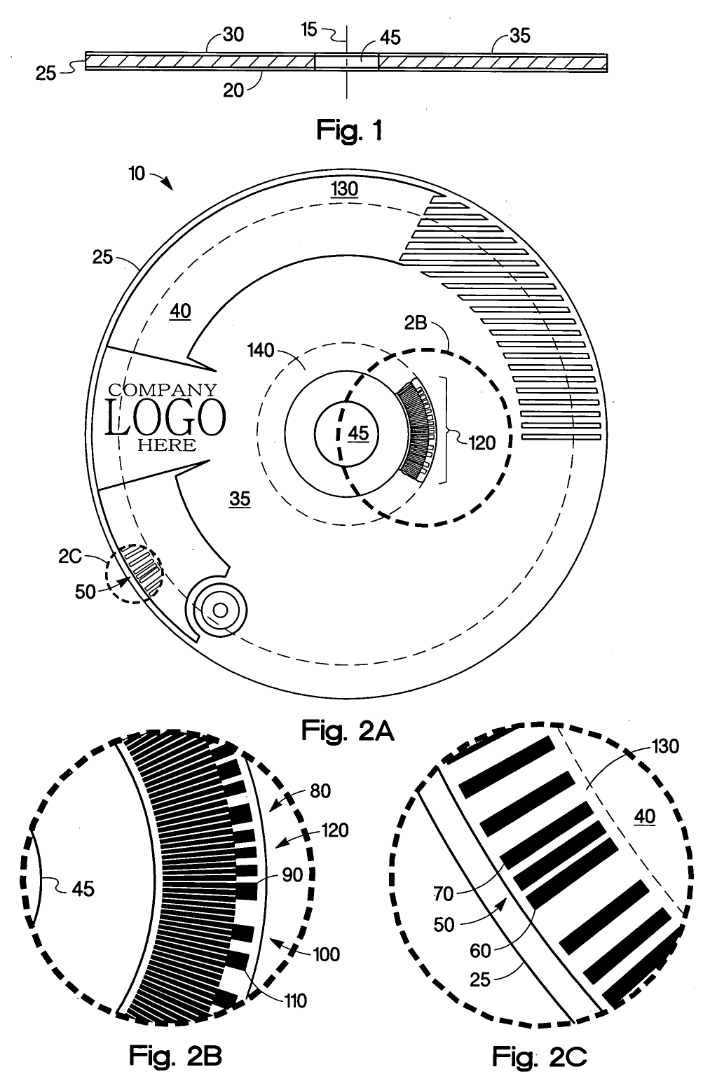

As shown in FIGS. 1 and 2A-2C, one aspect of the invention provides embodiments of a recordable medium 10 having a data side 20 and a label side 30. Recordable medium 10 may have one or more template patterns 40 printed on the label side 30, including at least first indicia 50, the first indicia 50 including a template identification 60 and a template-reference-position mark 70. A template pattern or patterns 40 may also include second indicia 80 readable from at least one of the data side and label side, the second indicia 80 including at least one media-reference-position mark 90. The label side 30 of recordable medium 10 may be adapted for label marking by having a coating 35 of laser-sensitive material. Both the first and second indicia may be readable from the label side 30 of the recordable medium 10.

Template pattern 40 may be printed by any convenient method, such as screen printing, offset printing, inkjet printing, or any other suitable printing method compatible with the materials and form of the recording medium 10. For the embodiments described herein, it is generally not necessary to orient recordable medium 10 in any particular orientation when printing template pattern 40. If desired, the template pattern may be printed with inks that are substantially transparent to the laser radiation to be used to record on the label side of recordable medium 10. For some applications, the template pattern 40 may be printed with inks that are not visible to the human eye but are detectable by suitable detectors.

The data side 20 of recordable medium 10 may also be adapted for recording by having a coating of laser-sensitive material, or that data side may have pre-recorded data, such as data molded into the recordable medium 10 during its manufacture, or both.

In addition to first indicia 50 (including the template identification 60 and the template-reference-position mark 70) and second indicia 80 (including the media-reference-position mark 90), recordable medium 10 may also include third indicia 100 readable from at least one of the data side and label side. The third indicia 100 may include media-type identification information 110. For example, indicia 100 may identify the medium as one of an optical storage disk, a compact disk (CD), a digital versatile disk (DVD), an HD-DVD, a Blu-ray Disc™ (BD), a holographic versatile disk (HVD), a video disk, or a combination of these media types. Indicia 100 may also identify the media type as a disk type having a laser-recordable coating on at least a portion of the label side.

The second indicia 80 and third indicia 100 may be combined to form combined indicia 120, to include at least one media-reference-position mark 90 together with at least one media-type identification code 110. The code 110 may include information identifying the media type as a disk type of a set of disk types having a laser-recordable coating on at least a portion of the label side. Thus, the media-type identification information 100 of the recordable medium may comprise a code 110 identifying the media type as a compact disk (CD), a digital versatile disk (DVD), a video disk, or the like, having a laser-recordable coating on at least a portion of the label side.

One or more of the first, second, and third indicia (50, 80, and 100) may include a bar code. Therefore, the combined second and third indicia 120 may comprise a bar code, and in that bar code, the media-reference-position mark 90 may comprise at least one bar or space of the bar code. Such a bar or space may conveniently be identified, for example, by being incorporated into a predetermined bar-code portion or, alternatively, by being disposed adjacent to a predetermined bar-code portion, e.g., by immediately following a predetermined code.

The first, second, and third indicia (50, 80, and 100 respectively) may all be readable from at least the label side 30 of the recordable medium 10. Generally, positions of the various indicia are not critical, but certain positions are advantageous for use of the embodiments described. For example, the first indicia 50 and the second indicia 80 may be disposed within separate annular zones at different predetermined radial distances from the center of the recordable medium 10. Specifically, in some embodiments, the first indicia 50 may be disposed within an annular zone 130 at a first radial distance from the center 15 of the recordable medium 10, and the second indicia 80 may be disposed within a separate annular zone 140 at a second radial distance from the center 15 of the recordable medium 10, the second radial distance being smaller (or alternatively, larger) than the first radial distance. Similarly, the template-reference-position mark 70 and the media-reference-position mark 90 may be disposed within separate annular zones at different predetermined radial distances from the center 15 of the recordable medium 10. Specifically, in some embodiments, the template-reference-position mark 70 may be disposed within an annular zone at a first radial distance from the center 15 of the recordable medium, and the media-reference-position mark 90 may be disposed within a separate annular zone at a second radial distance from the center 15 of the recordable medium 10, the second radial distance being smaller than the first radial distance.

Other ways of characterizing the positions of various indicia in various embodiments relate to positions relative to the outer rim 25 and/or the central hole 45 of recordable medium 10, shown in FIG. 2A. For example, the template-reference-position mark 70 may be disposed within an annular zone disposed within a predetermined tolerance of the outer rim 25 of the recordable medium 10. Similarly, the media-reference-position mark 90 may be disposed within an annular zone disposed within a predetermined tolerance of the central hole 45 of the recordable medium 10.

Any of the indicia, and specifically the template-reference-position mark 70 and the media-reference-position mark 90 may be disposed with a predetermined azimuthal angular relationship to each other. For example, the template-reference-position mark 70 and the media-reference-position mark 90 may be disposed at azimuthal angular positions substantially orthogonal to each other, i.e., at 90 angular degrees apart in azimuth (not as shown in FIG. 2A). While this particular azimuthal angular relationship is not shown in FIG. 2A, the azimuthal angular relationship may be different in various embodiments.

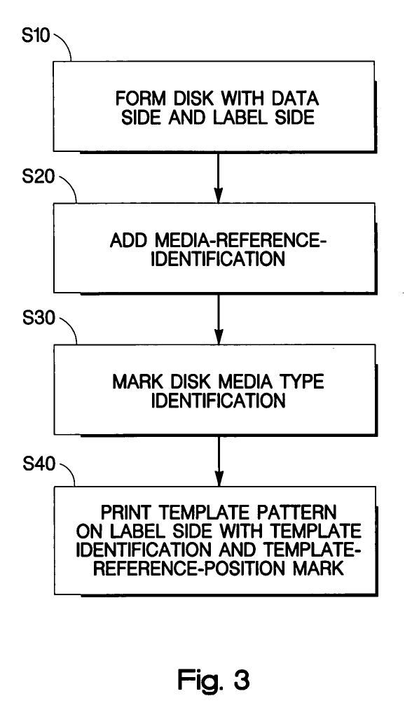

Another aspect of the invention is an embodiment of a method for manufacturing an article, as illustrated in FIG. 3. Method steps are identified by reference numerals S10, S20, . . . , S40. The method embodiment includes forming a disk (step S10) having a data side 20 and a label side 30, each of the sides being adapted for laser recording, marking the disk (step S20) with indicia including a media-reference-position mark 90 and including a code 100 identifying the disk (step S30) as one of a type having a laser-recordable coating on at least a portion of the label side, and printing a template pattern 40 (step S40) on the label side of the disk, the template pattern 40 including a template identification 60 and a template-reference-position mark 70. Thus, a recordable disk medium embodiment made by such a method has many of the functional features of the recordable media 10 described above and illustrated in FIGS. 1 and 2A-2C.

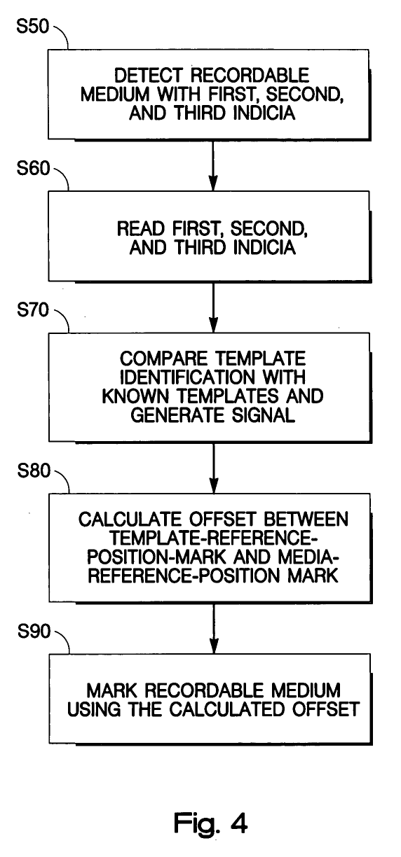

Other aspects of the invention provide embodiments of methods for using embodiments of a recordable medium 10 described above. FIG. 4 illustrates various embodiments of such methods. Method steps are identified by reference numerals S50, S60, . . . , S90. Such method embodiments include steps of detecting recordable medium 10 (step S50), reading at least the first and second indicia 50 and 80 of the detected recordable medium (step S60), comparing the template identification 60 of the first indicia 50 with a predetermined list of known templates and generating a signal indicative of whether a known template is present (step S70), calculating an offset between the template-reference-position mark 70 of the first indicia 50 and the media-reference-position mark 90 of the second indicia 80 (step S80), and marking the recordable medium 10, using the calculated offset (step S90).

Yet another aspect of the invention provides embodiments of a recordable medium 10 having a data side 20 and a label side 30, including one or more template patterns 40 printed on the label side 30 (the template patterns including at least first indicia 50 and the first indicia 50 including a template-reference-position mark 70). The recordable medium 10 also includes second indicia 80 readable from at least one of the data side and label side (the second indicia 80 including at least one media-reference-position mark 90). The recordable medium 10 also includes third indicia 100 readable from at least one of the data side and label side (the third indicia 100 including media-type identification information 110). In some embodiments of such a recordable medium 10, the second and third indicia (80 and 100) are both disposed within a common annular zone 140 disposed within a predetermined tolerance of a predetermined radial distance from the center 15 (or equivalently from the central hole 45) of the recordable medium 10.

A related aspect of the invention is an embodiment of a method of using such embodiments of recordable medium 10. Such a method embodiment (also illustrated by FIG. 4) comprises steps of detecting the recordable medium 10 made as described above (step S50), reading at least the first, second, and third indicia (50, 80, and 100 respectively) of the detected recordable medium (step S60), comparing the template identification 60 of the first indicia 50 with a predetermined list of known templates corresponding to the media-type identification 110 of the third indicia and generating a signal indicative of whether a known template is present (step S70), calculating an offset between the template-reference-position mark 70 of the first indicia 50 and the media-reference-position mark 90 of the second indicia 80 (step S80) and marking the recordable medium 10 using the calculated offset (step S90).

### INDUSTRIAL APPLICABILITY

Media made and methods performed in accordance with the disclosed embodiments and their equivalents are useful in optical recording and in labeling of optical media. They may also be used in medical imaging applications, product technical support, or in publishing, advertising, and promotional applications, for example, and many other applications.

Although the foregoing has been a description and illustration of specific embodiments of the invention, various modifications and changes thereto can be made by persons skilled in the art without departing from the scope and spirit of the invention as defined by the following claims. For example, the template pattern and various indicia may be made as either positive or negative images. For another example, selected indicia may include security information such as authentication codes. For yet another example, the indicia may be readable only with illumination outside the human visual spectrum range.

What is claimed is:

1. A recordable medium having a data side and a label side, comprising: one or more template patterns printed on the label side, including at least first indicia, the first indicia including a template-reference-position mark.

2. The recordable medium of claim 1, wherein the at least first indicia further includes a template identification mark.

3. The recordable medium of claim 2, further comprising: second indicia readable from at least one of the data side and label side, the second indicia including at least one media-reference-position mark.

4. The medium of claim 3, wherein the label side of the recordable medium is adapted for label marking by having a coating of laser-sensitive material.

5. The medium of claim 3, wherein both the first and second indicia are readable from the label side of the recordable medium.

6. The medium of claim 3, further comprising third indicia readable from at least one of the data side and label side, the third indicia including media-type identification information.

7. The medium of claim 6, wherein the second and third indicia are combined to comprise:
a) at least one media-reference-position mark; and
b) at least one code identifying the media type as a disk type of a set of disk types having a laser-recordable coating on at least a portion of the label side.

8. The medium of claim 7, wherein the combined second and third indicia comprise a bar code, and the media-reference-position mark comprises at least one bar or space of the bar code.

9. The medium of claim 6, wherein one or more of the first, second, and third indicia includes a bar code.

10. The medium of claim 6, wherein the first, second, and third indicia are all readable from at least the label side of the recordable medium.

11. The medium of claim 3, wherein the first indicia and the second indicia are disposed within separate annular zones at different predetermined radial distances from the center of the recordable medium.

12. The medium of claim 11, wherein the first indicia are disposed within an annular zone at a first radial distance from the center of the recordable medium and the second indicia are disposed within a separate annular zone at a second radial distance from the center of the recordable medium, the second radial distance being smaller than the first radial distance.

13. The medium of claim 3, wherein the template-reference-position mark and the media-reference-position mark are disposed within separate annular zones at different predetermined radial distances from the center of the recordable medium.

14. The medium of claim 13, wherein the template-reference-position mark is disposed within an annular zone at a first radial distance from the center of the recordable medium and the media-reference-position mark is disposed within a separate annular zone at a second radial distance from the center of the recordable medium, the second radial distance being smaller than the first radial distance.

15. The medium of claim 3, wherein the recordable medium has an outer rim and wherein the template-reference-position mark is disposed within an annular zone disposed within a predetermined tolerance of the outer rim of the recordable medium.

16. The medium of claim 3, wherein the recordable medium has a central hole and wherein the media-reference-position mark is disposed within an annular zone disposed within a predetermined tolerance of the central hole of the recordable medium.

17. A method, comprising the steps of:
a) detecting a recordable medium made in accordance with claim 1,
b) reading at least the first and second indicia of the detected recordable medium,
c) comparing the template identification of the first indicia with a predetermined list of known templates and generating a signal indicative of whether a known template is present,
d) calculating an offset between the template-reference-position mark of the first indicia and the media-reference-position mark of the second indicia, and
e) marking the recordable medium, using the calculated offset.

18. A recordable medium having a data side and a label side, comprising:
a) one or more template patterns printed on the label side, including at least first indicia, the first indicia indicating a template-reference-position mark,
b) second indicia readable from at least one of the data side and label side, the second indicia including at least one media-reference-position mark, and
c) third indicia readable from at least one of the data side and label side, the third indicia including media-type identification information.

19. The medium of claim 18, wherein the second and third indicia are both disposed within a common annular zone disposed within a predetermined tolerance of a predetermined radial distance from the center of the recordable medium.

20. A method, comprising the steps of:
a) reading, by a computer, at least first indicia on a label side of a recordable medium, the label side including a printed template pattern and the first indicia including a template reference position mark;
b) using, by the computer, the first indicia to determine a location on the label side of the recordable medium;
c) marking, by the computer, the label side at the determined location.

21. The method of claim 20, wherein the marking is performed by exposing the location with a laser beam.

22. A method, comprising:
a) forming a disk having a data side and a label side, each of the sides being adapted for laser recording thereon,
b) marking the disk with indicia including a media-reference-position mark and including a code identifying the disk as one of a type having a laser-recordable coating on at least a portion of the label side,
c) printing a template pattern on the label side of the disk, the template pattern including a template identification and a template-reference-position mark.
